(19) United States
(12) Patent Application Publication
(10) Pub. No.: US 2013/0096236 A1
(43) Pub. Date: Apr. 18, 2013

(54) PLANT MATERIAL COMPOSITIONS AND METHOD FOR PREPARING SAME

(71) Applicants: Joel Bernaerts, Labeuvriere (FR); Laurie Coudyser, Loos (FR); Leon Mentink, Lille (FR); Didier Beaudoux, Cublize (FR); Bernard Constant, Cublize (FR)

(72) Inventors: Joel Bernaerts, Labeuvriere (FR); Laurie Coudyser, Loos (FR); Leon Mentink, Lille (FR); Didier Beaudoux, Cublize (FR); Bernard Constant, Cublize (FR)

(73) Assignee: ROQUETTE FRERES, Lestrem (FR)

(21) Appl. No.: 13/637,035

(22) PCT Filed: Mar. 24, 2011
(86) PCT No.: PCT/FR2011/050633

§ 371 Date: Dec. 21, 2012

(30) Foreign Application Priority Data
Mar. 25, 2010 (FR) 1052184

(51) Int. Cl. C08L 3/00

(52) U.S. Cl. CPC C08L 3/00
USPC 524/9; 524/52; 524/48; 524/51

(57) ABSTRACT

The present invention relates to a novel thermoplastic composition, characterized in that it contains: a) 15% to 60% of at least one starchy material; b) 10% to 30% of at least one starchy material plasticizer; c) 15% to 70% of at least one polyolefin; and d) 10% to 40% of at least one plant material selected among plant fibers and plant fillers. The invention also relates to a thermoplastic composition preparation method that includes the following steps: (i) selecting at least one composition (a) containing at least one starchy material, one plasticizer of said starchy material, and one polyolefin; (ii) selecting at least one plant material (b) selected among plant fibers and plant fillers, said plant material being formed of particles, the dimensions of which are between 0.5 and 5000 micrometers; and (iii) mixing the composition (a) and the plant material (b) so as to obtain the thermoplastic composition according to the invention.

The present invention relates to novel thermoplastic compositions comprising selected proportions of at least four components, namely, respectively, an amylaceous material, plasticizing agent for amylaceous material, polyolefin and plant material, said plant material being, in addition, selected from plant fibers and plant fillers. It also relates to a process for the preparation of these thermoplastic compositions.

The term “thermoplastic composition” is understood to mean, in the present invention, a composition which reversibly softens under the action of heat and hardens on being cooled. It exhibits at least one “glass transition” temperature (Tg) below which the amorphous fraction of the composition is in the brittle glassy state and above which the composition can undergo reversible plastic deformations. The glass transition temperature or one at least of the glass transition temperatures of the starch-based thermoplastic composition according to the present invention is preferably between −120° C. and 150° C. This thermoplastic composition exhibits an ability to be shaped by the processes conventionally used in industries for the transformation of plastics, textiles or wood, such as extrusion, injection molding, molding, rotational molding, thermoforming, blow molding, calendering or pressing.

Its viscosity, measured at a temperature of 100° C. to 200° C., is generally between 10 and 10⁶ Pa·s.

Preferably, said thermoplastic composition is a “hot melt” composition, that is to say that it can be shaped without application of high shear forces, that is to say by simple flowing or by simple pressing of the melt. Its viscosity, measured at a temperature of 100° C. to 200° C., is generally between 10 and 10³ Pa·s.

The term “plant material” is understood to mean, within the meaning of the present invention, a product of plant origin, of essentially polysaccharide nature, in particular cellulose, hemicellulose, ligneous or amylaceous nature, of essentially protein nature or based on natural rubbers and existing in the form of particles or in the form of a fibrous material. In the context of the invention, said plant material is chosen from plant fibers and plant fillers, as will be described subsequently in the present patent application.

In the current environmental and economic context of increased scarcity of oil and gas reserves from which conventional plastics, also known as petroleum-based plastics, are derived, in contrast to bioplastics based on renewable resources, of climatic disturbances due to the greenhouse effect and global warming, of the state of public opinion in search of sustainable development and of products which are more natural, cleaner, healthier, recyclable and more energy efficient, and of the change in regulations and tax systems, it is necessary to have available novel compositions resulting from renewable resources which are simultaneously competitive, designed from the start to have only few or no negative impacts on the environment and technically as effective as the materials prepared from starting materials of fossil origin.

In this spirit, various routes have already been explored for several decades, consisting in introducing biosourced materials as fillers into petroleum-based plastic resins. These fillers exhibit the twofold advantage of being low in density in comparison with inorganic fillers and of being of natural origin and renewable in the short term. Among petroleum-based plastic resins, polyolefins exhibit, for their part, the advantages of being produced in very large volumes at relatively low cost, of exhibiting advantageous eco-profiles with regard to the environment, of being able to be incinerated without producing toxic gases, in contrast to PVC, for example, and of being recyclable industrially.

Among plant materials, many studies have related to the incorporation of up to 60% of plant fibers, such as, in particular, flax and hemp fibers, cereal straw fibers, kenaf fibers, wood fibers or cellulose (rayon) fibers, in petroleum-based plastic resins, such as, in particular, in polypropylene. Products commonly known as natural fiber compounds are thus obtained. Reference may be made, for example, to the following thesis:

“Interfacial Interactions in Fiber Reinforced Thermoplastic Composites” by Livia Dányádi, Laboratory of Plastics and Rubber Technology, Department of Physical Chemistry and Materials Science, Budapest University of Technology and Economics, Institute of Materials and Environmental Chemistry Chemical Research Center, Hungarian Academy of Sciences, 2009.

This compounding operation is today fairly well mastered, although many studies are still being carried out for the purpose of improving the production and the characteristics of these compounds. This is because the introduction of such fibers is not easy, considering that the plant fibers are generally very hydrophilic whereas the resins are hydrophobic in nature. In fact, it is recommended to dry these fibers in order to reduce their hydrophobic nature and to use synthetic products, generally of petroleum origin, as dispersing agents, compatibilizing agents and/or coupling agents, but also specific stabilizing agents, considering the high instability of plant fibers toward shearing, heat, light and microorganisms. Furthermore, the maximum amounts of material of plant origin which it is possible to introduce into petroleum-based plastic resins without compromising their properties remain relatively limited and in normal practice are less than 50%.

Other types of plant materials have also been introduced, as fillers, into petroleum-based plastic resins so as to correct the failings listed above or to obtain advantageous properties.

This is the case with starch, which has been introduced as filler in a granular state, in particular into polyolefins. Reference may be made in this context, for example, to patent application WO 2009 022195, which describes composites of polyolefins and of granular starch. This starch then constitutes a plant filler exhibiting the advantage of being itself also renewable but in particular being available in large amounts at an economically advantageous cost with respect to oil and gas.

A granular starch is a starch having a structure as semicrystalline granules similar to those demonstrated for the starch as present naturally in the storage tissues and organs of higher plants, in particular in seeds of cereals, seeds of leguminous plants, tubers of potato or cassava, roots, bulbs, stems and fruits. This semicrystalline state is essentially due to the macromolecules of amylopectin, one of the two main constituents of starch. In the native state, starch grains exhibit a degree of crystallinity which varies from 15 to 45% and which depends essentially on the botanical origin of the starch and on any treatment which it has been subjected to. Granular starch, placed under polarized light, exhibits in microscopy a characteristic cross, referred to as “Maltese cross”, typical of the crystalline granular state. For a more detailed description of granular starch, reference may be made to Chapter II, entitled “Structure et morphologie du grain d'amidon” [Structure and morphology of the starch grain], by S. Perez, in the work “Initiation à la chimie et à la physico-chimie macromoléculaires” [Introduction to macromolecular chemistry and physicochemistry], first edition, 2000, Volume 13, pages 41 to 86, Groupe Français d'Etudes et d'Applications des Polymères [French Group for Studies and Applications of Polymers].

Such granular starches, that is to say starches in the structural state where they occur in the storage organs of plants, are insoluble in water. Before dispersion in the synthetic polymer forming the matrix or continuous phase, it has been recommended to dry the native starch down to a moisture content of less than 1% by weight, in order to reduce its hydrophilic nature and thus to facilitate the dispersion thereof. With this same aim, it has been recommended to coat it beforehand with fatty substances (fatty acids, silicones, siliconates) or also to modify the surface of the starch grains with siloxanes or isocyanates or, finally, to combine therewith synthetic dispersants of different chemical nature, such as, for example, polyethylene glycols or ethylene/vinyl acetate (EVA) copolymers. The composites thus obtained then generally comprise at most 20% by weight of granular starch as, above this value, the mechanical properties of the composite materials obtained become excessively modified or excessively reduced in comparison with those of the synthetic polymers forming the matrix. The rapid expansion of such composites, sometimes also referred to as hybrids, has remained limited.

More recently, starch has been combined with polyolefins, in quite another state known as “destructured” or “thermoplastic”, this being achieved according to a completely different technology. This destructured or thermoplastic state of the starch is obtained by plasticizing granular starch by incorporating an appropriate plasticizer at a content generally of between 15 and 35%, with respect to the granular starch, and by providing mechanical and thermal energy. Patents U.S. Pat. No. 5 095 054 from Warner Lambert and EP 0 497 706 B1 from the applicant company describe in particular this destructured state, having a reduced or absent crystallinity by virtue of the addition of plasticizer, and means for obtaining such thermoplastic starches. The destructuring of the semicrystalline native granular state of the starch in order to obtain amorphous thermoplastic starches can be carried out in a medium of relatively low hydration by thermomechanical or extrusion processes. The achievement of a molten phase from granular starch requires not only a significant contribution of mechanical energy and of thermal energy but also the presence of a plasticizer at the risk, otherwise, of carbonizing the starch.

The combination of thermoplastic starch and of polyolefins makes it possible to obtain thermoplastic compositions, the properties of which can be adjusted by the choices of the type of starch, of the nature of the plasticizer, of the plasticizing ratio, of the degree of incorporation of thermoplastic starch in the polyolefins, and of the mixing process. The thermoplastic compositions thus obtained ordinarily exhibit a structure where the thermoplastic starch is present in dispersed form as islets in a continuous polyolefin phase. This is explained by the fact that the thermoplastic starches are very hydrophilic and consequently have very little miscibility or very low compatibility with the polyolefins. Ordinarily, in order to improve the structure of these mixtures, compatibilizing agents or coupling agents, such as, for example, copolymers comprising alternating hydrophobic units and hydrophilic units, such as ethylene/acrylic acid (EAA) copolymers, polyolefins grafted by maleic anhydride groups or organosilanes, are added thereto. Great advances have made it possible in recent years to obtain novel thermoplastic compositions exhibiting excellent mechanical properties in terms of stiffness, bending and impact strength by the development of novel processes, such as those which have formed the subject matter of patent applications WO 2009/095617, WO 2009/095618, WO 2009/095622 and WO 2010/010282 published on behalf of the applicant company.

The present invention provides a novel and advantageous solution to the problems listed above by providing novel thermoplastic compositions prepared from at least four components, including at least one amylaceous material and at least one polyolefin, and exhibiting improved properties with respect to those of the prior art.

More specifically, a subject matter of the present invention is a thermoplastic composition, characterized in that it comprises:
a) from 15 to 60% of at least one amylaceous material,
b) from 10 to 30% of at least one plasticizing agent for amylaceous material with a molar mass of greater than 18 g/mol and less than 5000 g/mol,
c) from 15 to 65% of at least one polyolefin, and
d) from 10 to 40% of at least one plant material chosen from plant fibers and plant fillers,

said amylaceous material a) being plasticized by the plasticizing agent b) and these percentages being expressed by dry weight, with respect to the dry weight of said composition.

Preferably, said composition comprises:
a) from 15 to 50% of at least one amylaceous material,
b) from 10 to 25% of at least one plasticizing agent for amylaceous material,
c) from 25 to 50% of at least one polyolefin, and
d) from 15 to 40% of at least one plant material chosen from plant fibers and plant fillers.

According to an advantageous alternative form dependent on any one of the preceding alternative forms, said composition is characterized in that it comprises, in total, at least 27%, preferably from 30 to 80% and more preferably still from 35 to 75% of plasticized amylaceous material composed of a) and b), these percentages being expressed by total dry weight of amylaceous material(s) and of plasticizer(s) for amylaceous material, with respect to the dry weight of the thermoplastic composition.

According to a particularly advantageous alternative form dependent on any one of the preceding alternative forms, said composition is characterized in that it comprises, in total, at least 52%, preferably from 55 to 90%, of the plasticized amylaceous material, composed of at least one amylaceous material and at least one plasticizer for amylaceous material (constituents a and b), and of at least one polyolefin (constituent c), these percentages being expressed by total dry weight of amylaceous material(s), of plasticizer(s) for amylaceous material and of polyolefin(s), with respect to the dry weight of the thermoplastic composition.

This is because the applicant company has found, after numerous studies, that, surprisingly and unexpectedly, the use of the thermoplastic composition according to the invention combining, furthermore in defined proportions, a plasticized amylaceous material, a polyolefin and a plant fiber or filler made it possible, contrary to all expectations, to obtain, in comparison with the compositions of the prior art, in particular not comprising plant fiber or filler or comprising lesser or greater proportions thereof, improved mechanical properties and even made it possible to dispense with or to significantly reduce the amounts of compatibilizing agents or coupling agents ordinarily necessary in order to obtain satisfactory properties. Without wishing to be committed to any one theory, the applicant company believes that the plasticized amylaceous material itself behaves, in the composition, in the manner of a compatibilizing or coupling agent between the selected plant material and the other constituents of the composition, in particular the polyolefin.

The present invention also relates in particular to a thermoplastic composition according to the invention, characterized in that it is provided in the form of granules, chips, sheets, slabs, powders or fibrous mats capable of being formed by pressing, thermoforming, extrusion, calendering, injection molding or blow molding.

In view of the makeup of the composition according to the invention, the various constituents can be employed in any order and according to highly varied processes. It is possible, inter alia, to prepare an intermediate thermoplastic composition not comprising plant fiber or filler and then, by any appropriate means and according to appropriate proportions, to mix said intermediate composition with the plant fibers and/or fillers.

Furthermore, the applicant company has been able to find that the thermoplastic composition according to the invention exhibited, in comparison with the compositions of the prior art, in particular comprising a polyolefin but not plasticized amylaceous material, excellent properties in terms of interaction and of adhesion or bonding with regard to plant fibers or fillers, such as paper or board, so that, according to one alternative form, an intermediate composition not yet comprising plant fibers or fillers is prepared, which intermediate composition can subsequently be used, inter alia, as means for bonding together plants fibers and/or fillers.

Furthermore, another subject matter of the present invention is a process for improving the bonding together of plant fibers and/or fillers, characterized in that it comprises the following stages:
(i) selection of at least one plant material chosen from plant fibers and plant fillers,
(ii) selection of at least one composition comprising an amylaceous material plasticized by a plasticizer with a molar mass of greater than 18 g/mol and less than 5000 g/mol and a polyolefin, and
(iii) thermomechanical mixing of said plant material and said composition.

Stage (iii) is carried out at a temperature advantageously of between 80 and 200° C., preferably of between 120 and 185° C. and more preferably still of between 160 and 180° C. This stage can in particular be carried out by hot pressing, thermomolding, extrusion, injection molding and/or hot spraying of the intermediate composition over a screen of plant matter. It is thus possible to prepare, in particular, panels or “fibrous mats” which can be used, for example, as acoustic and/or thermal insulators and which can comprise 95% fibers, and indeed even more, of plant matter.

The intermediate composition devoid of plant fiber or filler which can be used for the purpose of the preparation of the thermoplastic composition according to the invention can in particular be characterized in that it comprises:
a) from 17 to 65% of at least one amylaceous material,
b) from 12 to 30% of at least one plasticizing agent for amylaceous material, and
c) from 17 to 70% of at least one polyolefin,
   these percentages being expressed by dry weight, with respect to the dry weight of said intermediate composition.

Preferably, said intermediate composition comprises:
a) from 20 to 65% of at least one amylaceous material,
b) from 12 to 25% of at least one plasticizing agent for amylaceous material, and
c) from 20 to 65% of at least one polyolefin.

According to an advantageous alternative form, said intermediate composition comprises:
a) from 25 to 60% of at least one amylaceous material,
b) from 15 to 25% of at least one plasticizing agent for amylaceous material, and
c) from 25 to 60% of at least one polyolefin.

Said intermediate composition which can be used according to the invention can in particular exhibit a density of between 0.95 and 1.3, preferably of between 1.0 and 1.25 and more preferably of between 1.05 and 1.15, in accordance with the standard ISO 1183.

The thermoplastic composition according to the invention or the intermediate composition which can be used for its preparation necessarily comprises a polyolefin. This polyolefin can be virgin, that is to say not having had prior use, although being able to be formulated by addition of additives or by compounding. It can also be recycled, that is to say originate from polyolefin parts or objects enhanced in value by recovery of material.

In the present invention, the term “polyolefin” is understood to mean a nonfunctionalized or nongrafted polyolefin or a blend of such a polyolefin with a functionalized or grafted polyolefin. In the case where the polyolefin is a blend of a nonfunctionalized and nongrafted polyolefin (PO1) and of a functionalized and/or grafted polyolefin (PO2), the (PO1)/(PO2) ratio can range from 1/99 to 99/1, advantageously from 10/90 to 90/10, for example from 25/75 to 75/25.

The polyolefin can be obtained from monomers of fossil origin and/or from monomers resulting from renewable natural resources, just as it can result from a pool of recycled material or material to be recycled.

Mention may in particular be made, as examples of nonfunctionalized or nongrafted polyolefins which can be used in the context of the present invention, of:
a) homopolymers of olefins, such as, for example, linear or radical low-density polyolefins (LDPEs), high-density polyethylenes (HDPEs), polypropylenes (PPs) of isotactic, syndiotactic or atactic form, polybutenes and polyisobutylenes,
b) copolymers based on at least two olefins, such as, for example, ethylene/propylene (P/E) copolymers, ethylene/butene copolymers and ethylene/octene copolymers,
c) any blend of at least any two of the abovementioned products.

Mention may in particular be made, as examples of functionalized or grafted polyolefins which can be used in the context of the present invention, as a blend with nonfunctionalized or nongrafted polyolefins, of:
a) homopolymers of functionalized or grafted olefins, for example olefins functionalized or grafted by acids or anhydrides, such as maleic, acrylic and methacrylic acids (or anhydrides), such as, for example, polyethylenes and polypropylenes grafted by maleic anhydride, by oxiranes, such as glycidyl methacrylate or acrylate, or by silanes,
b) copolymers based on at least two olefins, such as, for example, ethylene/propylene (P/E) copolymers, ethylene/butene copolymers and ethylene/octene copolymers, which are functionalized or grafted, for example, by acids or anhydrides, such as maleic, acrylic and methacrylic acids (or anhydrides), such as, for example, polyethylenes and polypropylenes grafted by maleic anhydride, by oxiranes, such as glycidyl methacrylate or acrylate, or by silanes,
c) any blend of at least any two of the abovementioned products.

In addition, the polyolefin can be synthesized from monomers resulting from natural resources renewable in the short term, such as plants, microorganisms or gases. The polyolefin can in particular be obtained from biosourced monomers, in particular from glycerol, bioethanol, biomethanol or biopropanediol.

Preferably, the polyolefin is chosen from the polyolefins obtained from biosourced monomers, and the blends of these.

Advantageously, the polyolefin exhibits a weight-average molecular weight of between 8500 and 10,000,000 g·mol⁻¹, in particular between 15,000 and 1,000,000 g·mol⁻¹.

The polyolefin is conventionally a nonbiodegradable or noncompostable resin within the meaning of the standards EN 13432, ASTM D 6400 and ASTM D 6868.

According to another preferred alternative form, the polyolefin is a polyolefin comprising at least 15%, preferably at least 30%, in particular at least 50%, better still at least 70%, indeed even more than 80% (including 100%), of carbon of renewable origin within the meaning of the standard ASTM D 6852 and/or the standard ASTM D 6866, with respect to all of the carbon present in said polyolefin.

This polyolefin is preferably chosen from the abovementioned nonfunctionalized or nongrafted polyolefins (olefin homopolymers, copolymers based on at least two olefins and any of their mixtures), such as linear or radical low-density polyethylene (LDPEs), high-density polyethylenes (HDPEs), polypropylenes (PPs) of isotactic, syndiotactic or atactic form, polybutenes, polyisobutylenes, ethylene/propylene (P/E) copolymers, ethylene/butene copolymers and ethylene/octene copolymers, and also any mixture of these.

The polyolefin can also be a blend of polyolefins, at least one of which can be functionalized or grafted, in particular can carry silane, acrylic or maleic anhydride units.

The thermoplastic composition according to the invention or the intermediate composition which can be used for its preparation also necessarily comprises at least one plasticized amylaceous material. It can in particular be a plasticized starch, the latter preferably exerting a degree of crystallinity of less than 15%, preferably of less than 5% and more preferably of less than 1%, that is to say can be in an essentially amorphous state.

This degree of crystallinity can in particular be measured by X-ray diffraction, as described in patent U.S. Pat. No. 5,362,777 (column 9, lines 8 to 24).

The plasticized starch is advantageously substantially devoid of starch grains exhibiting, in microscopy under polarized light, a Maltese cross, a sign indicative of the presence of crystalline granular starch.

The amylaceous material used for the preparation of the composition according to the invention or the intermediate composition which can be used according to the invention is preferably chosen from granular starches, water-soluble starches and organomodified starches.

According to a first alternative form, the amylaceous material is a granular starch. The crystallinity of said granular starch can be rendered less than 15% by a thermomechanical treatment with an appropriate plasticizing agent. Said granular starch can be of any botanical origin. It can be native starch of cereals, such as wheat, corn, barley, triticale, sorghum or rice, of tubers, such as potato or cassava, or of leguminous plants, such as pea and soya, starches rich in amylose or, conversely, rich in amylopectin (waxy) resulting from these plants, and any mixture of the abovementioned starches. The granular starch can also be a granular starch modified by any physical, chemical and/or enzymatic means. It can be a fluidized or oxidized granular starch or a white dextrin. It can also be a granular starch which has been modified physicochemically but which has been able to retain the structure of the starting native starch, such as esterified and/or etherified starches, in particular starches modified by grafting, acetylation, hydroxypropylation, anionization, cationization, crosslinking, phosphation, succinylation and/or silylation. Finally, it can be a starch modified by a combination of the treatments set out above or any mixture of such granular starches.

In a preferred embodiment, this granular starch is chosen from native starches, fluidized starches, oxidized starches, starches which have been subjected to a chemical modification, white dextrins and any mixture of these products.

The granular starch is preferably a wheat or pea granular starch or a granular derivative of wheat or pea starch. It generally exhibits a content of materials soluble at 20° C. in demineralized water of less than 5% by weight and can be virtually insoluble in cold water.

According to a second alternative form, the starch is a water-soluble starch which can also originate from any botanical source, including a water-soluble starch rich in amylose or, conversely, rich in amylopectin (waxy). This soluble starch can be introduced as partial or complete replacement for the granular starch.

“Water-soluble starch” is understood to mean, within the meaning of the invention, any starch-derived polysaccharide material which exhibits, at 20° C. and under mechanical stirring for 24 hours, a fraction soluble in demineralized water at least equal to 5% by weight. This soluble fraction is preferably greater than 20% by weight and in particular greater than 50% by weight. Of course, the soluble starch can be completely soluble in demineralized water (soluble fraction=100%).

The water-soluble starch is used in the solid form, preferably the essentially anhydrous solid form, that is to say not dissolved or not dispersed in an aqueous or organic solvent. It is thus important not to confuse, throughout the description which follows, the term “water-soluble” with the term “dissolved”.

Such water-soluble starches can be obtained by pregelatinization on a drum, by pregelatinization on an extruder, by atomization of an amylaceous suspension or solution, by precipitation with a nonsolvent, by hydrothermal cooking, by chemical functionalization or by another technique. It is in particular a pregelatinized, extruded or atomized starch, a highly converted dextrin (also known as yellow dextrin), a maltodextrin, a functionalized starch or a mixture of these products.

The pregelatinized starches can be obtained by hydrothermal gelatinization treatment of native starches or modified starches, in particular by steam cooking, jet-cooker cooking, cooking on a drum, cooking in kneader/extruder systems and then drying, for example in an oven, with hot air on a fluidized bed, on a rotating drum, by atomization, by extrusion or by lyophilization. Such starches generally exhibit a solubility in demineralized water at 20° C. of greater than 5% and more generally of between 10 and 100% and a degree of starch crystallinity of less than 15%, generally of less than 5% and most often of less than 1%, indeed even zero. Mention may be made, by way of example, of the products manufactured and sold by the applicant company under the Pregeflo® trade name.

The highly converted dextrins can be prepared from native or modified starches by dextrinization in a relatively anhydrous acidic medium. They can in particular be soluble white dextrins or be yellow dextrins. Mention may be made, by way of example, of the products Stabilys® A 053 or Tackidex® C 072 manufactured and sold by the applicant company. Such dextrins exhibit, in demineralized water at 20° C., a solubility generally of between 10 and 95% and a starch crystallinity of less than 15% and generally of less than 5%.

The maltodextrins can be obtained by acid, oxidizing or enzymatic hydrolysis of starches in an aqueous medium. They can in particular exhibit a dextrose equivalent (DE) of between 0.5 and 40, preferably between 0.5 and 20 and better still between 0.5 and 12. Such maltodextrins are, for example, manufactured and sold by the applicant company under the Glucidex® trade name and exhibit a solubility in demineralized water at 20° C. generally of greater than 90%, indeed even of close to 100%, and a starch crystallinity generally of less than 5% and ordinarily of virtually zero.

The functionalized starches can be obtained from a native or modified starch. The high functionalization can, for example, be achieved by esterification or etherification to a sufficiently high level to confer thereon a solubility in water. Such functionalized starches exhibit a soluble fraction as defined above of greater than 5%, preferably of greater than 10%, better still of greater than 50%.

The functionalization can be obtained in particular by acetylation in an aqueous phase with acetic anhydride or mixed anhydrides, hydroxypropylation in a tacky phase, cationization in a dry phase or tacky phase, or anionization in a dry phase or tacky phase by phosphation or succinylation. These water-soluble highly functionalized starches can exhibit a degree of substitution of between 0.01 and 3 and better still of between 0.05 and 1. Preferably, the reactants for modifying or functionalizing the starch are of renewable origin.

According to another advantageous alternative form, the water-soluble starch is a wheat or pea water-soluble starch or a water-soluble derivative of a wheat or pea starch.

It advantageously exhibits a low water content generally of less than 10% by weight, preferably of less than 5% by weight, in particular of less than 2% by weight and ideally of less than 0.5% by weight, indeed even of less than 0.2% by weight.

According to a third alternative form, the starch is an organomodified starch, preferably an organosoluble starch, which can also originate from any botanical source, including an organomodified starch, preferably an organosoluble starch, rich in amylose or, conversely, rich in amylopectin (waxy). This organosoluble starch can be introduced as partial or complete replacement for the granular starch or for the water-soluble starch.

“Organomodified starch” is understood to mean, within the meaning of the invention, any starch-derived polysaccharide material other than a granular starch or a water-soluble starch according to the definitions given above. Preferably, this organomodified starch is virtually amorphous, that is to say exhibits a degree of starch crystallinity of less than 5%, generally of less than 1%, and in particular a zero degree of starch crystallinity. It is also preferably “organosoluble”, that is to say exhibits, at 20° C., a fraction at least equal to 5% by weight soluble in a solvent chosen from ethanol, ethyl acetate, propyl acetate, butyl acetate, diethyl carbonate, propylene carbonate, dimethyl glutarate, triethyl citrate, dibasic esters, dimethyl sulfoxide (DMSO), dimethyl isosorbide, glycerol triacetate, isosorbide diacetate, isosorbide dioleate and methyl esters of plant oils. This soluble fraction is preferably greater than 20% by weight and in particular greater than 50% by weight. Of course, the organosoluble starch can be completely soluble in one or more of the solvents indicated above (soluble fraction=100%).

The organomodified starch can be used according to the invention in the solid form, preferably in the essentially anhydrous form. Preferably, its water content is less than 10% by weight, preferably less than 5% by weight, in particular less than 2% by weight and ideally less than 0.5% by weight, indeed even less than 0.2% by weight.

The organomodified starch can be prepared by a high functionalization of the native or modified starches, such as those presented above. This high functionalization can, for example, be carried out by esterification or etherification to a sufficiently high level to render it essentially amorphous and to confer on it an insolubility in water and preferably a solubility in one of the above organic solvents. Such functionalized starches exhibit a soluble fraction as defined above of greater than 5%, preferably of greater than 10%, better still of greater than 50%.

The high functionalization can be obtained in particular by acetylation in a solvent phase with acetic anhydride, grafting, for example in a solvent phase or by reactive extrusion, of acid anhydrides, of mixed anhydrides, of fatty acid chlorides, of oligomers of caprolactones or of lactides, hydroxypropylation and crosslinking in a tacky phase, cationization and crosslinking in a dry phase or in a tacky phase, anionization by phosphation or succinylation and crosslinking in a dry phase or in a tacky phase, silylation or telomerization with butadiene. These organomodified, preferably organosoluble, highly functionalized starches can in particular be acetates of starches, of dextrins or of maltodextrins or fatty esters of these amylaceous materials (starches, dextrins, maltodextrins) with fatty chains of 4 to 22 carbons, these combined products preferably exhibiting a degree of substitution (DS) of between 0.5 and 3.0, preferably of between 0.8 and 2.8 and in particular of between 1.0 and 2.7.

They can, for example, be hexanoates, octanoates, decanoates, laurates, palmitates, oleates and stearates of starches, of dextrins or of maltodextrins, in particular exhibiting a DS of between 0.8 and 2.8.

According to another advantageous alternative form, the organomodified starch is a wheat or pea organomodified starch or an organomodified derivative of a wheat or pea starch.

Preferably, in the context of the invention, the amylaceous material is chosen from native starches, pregelatinized starches, extruded starches, atomized starches, fluidized starches, oxidized starches, cationic starches, anionic starches, hydroxyalkylated starches, crosslinked starches, starch acetates, fatty esters of starch and of fatty chains of 4 to 22 carbons, dextrins, maltodextrins and any mixture of these products. Very preferably, the amylaceous material used as constituent a is a native starch.

Furthermore, the thermoplastic composition according to the invention or the intermediate composition which can be used according to the invention comprises a plasticizing agent of amylaceous material.

The term “plasticizing agent” is understood to mean any organic molecule of low molecular weight, that is to say having a molecular weight of less than 5000 and greater than 18 g/mol, which, when it is incorporated by a thermomechanical treatment at a temperature of between 20 and 200° C. in the thermoplastic composition according to the invention, in the intermediate composition which can be used according to the invention or in just the amylaceous material, results in a decrease in the glass transition temperature of said composition or material and/or results in reducing the crystallinity of the amylaceous material until it is possible for it to reach an essentially amorphous state.

Water is the most natural plasticizer for amylaceous material, in particular for starch, and it is consequently commonly employed.

The plasticizing agent selected in the context of the present invention is preferably chosen from diols, triols and polyols, such as glycerol, polyglycerol, isosorbide, sorbitans, sorbitol, mannitol, sugars, such as glucose, maltose, fructose or sucrose, or also hydrogenated glucose syrups, salts of organic acids, such as sodium lactate, urea and the mixtures of these products. The plasticizer then advantageously exhibits a molar mass of less than 5000, preferably of less than 1000 and in particular of less than 400. The plasticizing agent preferably has a molar mass at most equal to 380.

It can, when the amylaceous material consists of an organomodified starch, be chosen very particularly from the methyl, ethyl or fatty esters of organic acids, such as lactic acid, citric acid, succinic acid, adipic acid and glutaric acid, and the acetic esters or fatty esters of monoalcohols, diols, triols or polyols, such as ethanol, diethylene glycol, glycerol and sorbitol. Mention may be made, by way of example, of glycerol diacetate (diacetin), glycerol triacetate (triacetin), isosorbide diacetate, isosorbide dioctanoate, isosorbide dioleate, isosorbide dilaurate, esters of dicarboxylic acids or dibasic esters (DBEs), and the mixtures of these products.

According to an advantageous alternative form, the plasticizer is present in the plasticized amylaceous material in a proportion of 25 to 110 parts by dry weight, preferably in a proportion of 30 to 100 parts by dry weight and in particular in a proportion of 30 to 90 parts by dry weight, per 100 parts by dry weight of amylaceous material, for example starch.

The thermoplastic composition according to the invention or the intermediate composition which can be used according to the invention preferably comprises, as plasticized amylaceous material, at least one plasticized starch obtained from native starches, pregelatinized starches, extruded starches, atomized starches, fluidized starches, oxidized starches, cationic starches, anionic starches, hydroxyalkylated starches, crosslinked starches, starch acetates, fatty esters of starch and of fatty chains of 4 to 22 carbons, dextrins, maltodextrins and any mixture of these products, plasticized by thermomechanical mixing by one at least of the plasticizing agents listed above.

The composition according to the invention can also comprise a coupling agent.

“Coupling agent” is understood to mean, in the present invention, any organic molecule carrying at least two free or masked functional groups capable of reacting with molecules carrying functional groups having active hydrogen, such as the amylaceous material, for example starch, or the plasticizer of the amylaceous material. This coupling agent can be added to the composition in order to make possible the attaching, via covalent bonds, of at least a portion of the plasticizing agent to the starch, indeed even also to the polyolefin, in particular if the latter carries functional groups.

This coupling agent can then be chosen, for example, from compounds carrying at least two identical or different and free or masked functional groups chosen in particular from isocyanate, carbamoylcaprolactam, aldehyde, epoxide, halo, protonic acid, acid anhydride, acyl halide, oxychloride, trimetaphosphate or alkoxysilane functional groups and combinations of these.

It can advantageously be chosen from the following compounds:

Mention may be made, as coupling agents which can be used in the present invention, of:
diisocyanates, preferably methylenediphenyl diisocyanate (MDI), isophoronediisocyanate (IPDI), dicyclohexylmethane diisocyanate (H12MDI), toluene diisocyanate (TDI), naphthalene diisocyanate (NDI), hexamethylene diisocyanate (HMDI) or lysine diisocyanate (LDI), the aliphatic diisocyanate with a molar mass of 600 g/mol obtained from fatty acid dimers (DDI®01410 Diisocyanate),
dimers, trimers and tetramers of diisocyanates,
triisocyanates, tetraisocyanates and respective homopolymers of existing di-, tri- and tetraisocyanates,
“isocyanate-free” prepolymers resulting from a reaction of a diol or amine with a diisocyanate under conditions such that the prepolymer comprises an isocyanate functional group at each of its ends (α,ω-functional or telechelic polymer) without it being possible to detect free diisocyanate, isocyanate prepolymers of dendrimer type, prepared from compounds exhibiting several alcohol or amine functional groups and from polyisocyanates, prepared so that the dendrimer formed exhibits only reactive isocyanate functional groups at the branch end, the dendrimer comprising or not comprising free di- or triisocyanates,
dialkyl carbonates, in particularly dialkyl carbonates of dianhydrohexitols, especially isosorbide dialkylcarbonates,
dicarbamoylcaprolactams, preferably 1,1′-carbonylbiscaprolactam,
diepoxides,
compounds comprising an epoxide functional group and a halide functional group, preferably epichlorohydrin,
organic diacids, preferably succinic acid, adipic acid, glutaric acid, oxalic acid, malonic acid, maleic acid or corresponding anhydrides,
polyacids and polyanhydrides, preferably mellitic acid or its derivatives, such as trimellitic acid or pyromellitic acid,
oxychlorides, preferably phosphorus oxychloride,
trimetaphosphates, preferably sodium trimetaphosphate,
alkoxysilanes, preferably tetraethoxysilane,
heterocyclic compounds, preferably bis-oxazolines, bis-oxazolin-5-ones and bis-azalactones,
derivatives of methylenic or ethylenic diesters, preferably derivatives of methyl or ethyl carbonates,
any mixture of at least any two of the abovementioned products.

Use is particularly preferably made, as coupling agent, of a diisocyanate and in particular methylenediphenyl diisocyanate (MDI). Furthermore, the use of isophorone diisocyanate (IPDI) or dicyclohexylmethane diisocyanate (H12MDI) makes it possible to obtain final compositions which are in particular very slightly colored. Use may be made of any mixture of at least any two of the three abovementioned diisocyanates (MDI, IPDI and H12MDI).

The amount of coupling agent, expressed by dry weight and with respect to the sum, expressed by dry weight, of the composition according to the invention, can advantageously be between 0.1 and 15% by weight, preferably between 0.1 and 12% by weight, more preferably still between 0.2 and 9% by weight and in particular between 0.5 and 5% by weight.

The incorporation of the coupling agent in the mixture of the composition according to the invention or, preferably, in the intermediate composition which can be used according to the invention can be carried out by physical mixing under cold conditions or at low temperature but preferably by kneading under hot conditions at a temperature greater than the glass transition temperature of the amylaceous material. This kneading temperature is advantageously between 60 and 200° C. and better still from 100 to 160° C. This incorporation can be carried out by thermomechanical mixing, batchwise or continuously and in particular in line. In this case, the mixing time can be short, from a few seconds to a few minutes.

The composition according to the invention or the intermediate composition which can be used for the preparation thereof can advantageously comprise, in addition, an agent which improves its impact strength, in particular at a temperature of 23° C. or less, such as −18° C. It can in particular be a polymer of ethylene/propylene, ethylene/styrene or styrene/butadiene copolymer type, or an elastomeric material of natural rubber, styrene/butylene/styrene (SBS) copolymer or styrene/ethylene/butylene/styrene (SEBS) copolymer type. This strength-improving agent can represent from 1 to 15% by weight (dry/dry), preferably from 2 to 12% by weight (dry/dry) and better still from 5 to 10% by weight (dry/dry), of the composition according to the invention.

The thermoplastic composition according to the invention or the intermediate composition which can be used for the preparation thereof advantageously exhibits the following preferred alternative forms, taken separately or in combination, including with the alternative forms described above:
it comprises, in total, at least 51%, preferably at least 70% and in particular more than 80% of carbon-based biosourced materials of renewable origin within the meaning of standard ASTM D 6852 and/or of standard ASTM D 6866, expressed by dry weight with respect to the dry weight of said composition,
it is nonbiodegradable or noncompostable within the meaning of standards EN 13432, ASTM D 6400 and ASTM D 6868,
it exhibits a maximum flexural strength (according to standard ISO 178) of greater than 10 MPa and preferably greater than 20 MPa, and/or
it exhibits a maximum tensile strength (according to standard ISO 527) of greater than 10 MPa and preferably greater than 15 MPa.

Furthermore, the composition according to the invention exhibits particularly advantageous mechanical characteristics.

It can in particular be characterized in that it exhibits:
a maximum flexural strength (ISO 178) of greater than 30 MPa, and/or
a maximum tensile strength (ISO 527) of greater than 20 MPa.

The present invention makes it possible in particular to obtain a novel thermoplastic composition based on amylaceous material, on plasticizer for amylaceous material, on polyolefin and on plant fiber or filler, characterized in a notable way in that it simultaneously exhibits:
a maximum flexural strength of greater than 30 MPa, in particular of greater than 35 MPa, and
a maximum tensile strength of greater than 50 MPa, in particular of greater than 55 MPa.

It can also be characterized in that it exhibits a flexural modulus (ISO 178) and/or a tensile modulus (ISO 527) of greater than 1000 MPa, in particular of greater than 1500 MPa.

It can advantageously be characterized in that it exhibits a flexural modulus (ISO 178) and a tensile modulus (ISO 527) which are greater than 1500 MPa, in particular greater than 2000 MPa.

The plant material constituting the fourth essential component of the thermoplastic composition according to the invention is, as mentioned above, selected not only by its degree of introduction in said composition but also by its nature, namely chosen from plant fibers and plant fillers. It is selected for the purpose of improving the cold mechanical properties of the composition according to the invention but also its stability toward heat, and its thermomechanical properties, its conductive properties and/or its organoleptic properties, such as its appearance, its color or its odor.

The plant material thus selected in the form of plant fibers and/or fillers is composed of particles for which the greatest dimension is generally between 0.5 and 5000 micrometers and preferably between 0.5 and 1000 micrometers. Advantageously, it can be composed of a mixture of small particles for which the greatest dimension is between 0.5 and 300 micrometers and preferably between 100 and 275 micrometers and of large particles for which the greatest dimension is between 350 and 5000 micrometers and preferably between 400 and 3000 micrometers, the ratios by weight of the small particles/large particles generally varying from 0.1 to 9 and preferably from 0.5 to 2. Thus, it is possible to adjust as best as possible the thermomechanical characteristics and the organoleptic characteristics of the thermoplastic composition according to the invention.

By convention, in the context of the present invention and with regard to the plant fibers and fillers, the term “dimension” will be used to describe the greatest dimension of the particles of said fibers or fillers, it being possible for the latter to be provided under highly varied appearances (granules, powders, fibers, chips, and the like), it being possible for their greatest dimension, on an individual basis, to be regarded as being their diameter, their length or any other dimension which can be easily and commonly measured by a person skilled in the art.

Furthermore, the plant filler or fiber thus selected according to the invention generally exhibits a water content of between 0.5 and 30%, preferably between 1 and 20% more preferably still between 1 and 15%. This water content can advantageously be between 2 and 15%.

The plant filler can be chosen in particular from granular starches which are native or modified, as defined above, and nonplasticized. For this reason, this starch, placed under polarized light, always exhibits in microscopy a “Maltese cross” typical of the crystalline granular state. The starch selected as plant material can originate from any botanical source, including a starch rich in amylose or, conversely, rich in amylopectin (waxy). Preferably, this granular starch is a pea starch, a wheat starch, a waxy rice starch or a waxy corn starch. It has been shown that these preferred granular starches are advantageous in terms of whiteness and of appearance of the compositions according to the invention. It can in particular be a waxy corn starch.

When the plant filler is chosen from granular starches, their dimensions are generally between 0.5 and 100 micrometers, in particular between 1 and 70 micrometers. Advantageously, these dimensions are between 2 and 50 micrometers, preferably between 4 and 45 micrometers and more preferably between 5 and 40 micrometers. These dimensions can very particularly be between 8 and 35 micrometers, in particular between 10 and 30 micrometers.

The plant filler can also be chosen from nonfibrous coproducts from starch, flour, sugar, paper or oil mills. The fillers can in particular be wheat or triticale gums, oilseed cakes or homing feed, guar or locust bean flours, cereal or tuber proteins which make it possible in particular to obtain beige to brown tints, rosins or terpene resins which make it possible, for example, to improve the adhesion properties.

The plant filler can also be chosen from algae or algal extracts. The fillers can in particular be dried and milled whole algae or be algal extracts, such as polysaccharides, for example alginates and carrageenans.

The plant fiber can for its part also be chosen from cellulose or lignocellulose fibers and in particular from fibrous coproducts from starch, flour, sugar, paper or oil mills. It can then be provided as individual fibers, in distinctive form, as clusters or as agglomerates. Cereal brans, spent corn grain, wheat or triticale fibers, rice husks, sunflower husks, outer husks of seeds, beet or potato pulps, sugarcane bagasse, or walnut, hazelnut or almond shells may be concerned. Wood in the form of sawdust, in particular from beech, oak, birch, eucalyptus, pine or fir, may in particular be concerned. Spruce wood may also be concerned. Fibrous cellulose bodies composed of fibrils with a diameter in the vicinity of 10 to 100 nanometers for a length from a few micrometers to a few centimeters, such as paper or board, may also be concerned. Lignocellulose fibers, such as wood, flax, hemp, bamboo, sisal, miscanthus, banana, pea, potato, cereal, palm, coconut, jute, straw, cotton, kenaf or other fibers, may also be concerned. Mention may be made, for example, as products which can advantageously be used among these fibers, of sisal, bamboo, coconut or jute fibers.

Plant fibers or fillers which can be potentially used according to the invention are described in particular in patent applications WO 94/03543, CA 2 217 541 and EP 1 265 957.

The plant material which can be used according to the invention can very obviously be any mixture of at least any two of the abovementioned plant fibers and/or fillers.

Preferably, it exhibits, during the use thereof, that is to say during the incorporation thereof to form a composition according to the invention, a water content corresponding to its equilibrium moisture content in an atmosphere having a relative humidity of 66% and at a temperature of 20° C.

It can advantageously be chosen in order to increase the nucleation or the aptitude for crystallization of the polyolefin present in the thermoplastic composition (a) and in order to thus make it possible to adjust the mechanical properties and the shrinkage properties of the composition according to the invention.

According to an advantageous alternative form, the plant material is composed of particles having a dimension of between 0.5 and 5000 micrometers and is chosen from:
native or modified granular starches,
coproducts from starch, flour, sugar, paper or oil mills,
cellulose or lignocellulose fibers,
algae and algal extracts, and
any mixture of at least any two of these products.

Preferably, the plant material is chosen from cellulose or lignocellulose fibers, such as wood, sisal, bamboo, coconut or jute fibers.

The thermoplastic composition according to the invention exhibits the advantage of being quite low in density and of exhibiting a density, measured according to the ISO 1183 method, of between 1.05 and 1.25 and preferably of between 1.1 and 1.2.

Furthermore, the composition according to the invention or the intermediate composition which can be used for the preparation thereof can comprise other polymers, of any nature, in a small amount, in order to adjust its characteristics. However, it will preferably comprise polymers or copolymers other than polyolefins which are partially or completely biosourced, such as, in particular, polyurethanes (PUs), thermoplastic polyurethanes (TPUs), polyamides, polylactates (PLAs), polybutylene succinates (PBSs, PBSAs), polyhydroxyalkanoates (PHAs, PHBs, PHBVs) or any mixture of these.

Fillers and other additives of any nature, including those described in detail below, can also be incorporated in the composition of the present invention or the intermediate composition which can be used for the preparation thereof.

They can be products targeted at yet further improving its physicochemical properties, in particular its physical structure, its processing behavior and its durability, or else its mechanical, thermal, conductive, adhesive or organoleptic properties.

The additive can be an agent which improves or adjusts the mechanical or thermal properties chosen from inorganic materials, salts and organic substances. It can relate to nucleating agents, such as talc, to compatibilizing or dispersing agents, such as natural or synthetic surface-active agents, to agents which improve the impact strength or scratch resistance, such as calcium silicate, to agents which regulate shrinkage, such as magnesium silicate, to agents which trap or deactivate water, acids, catalysts, metals, oxygen, infrared radiation or UV radiation, to hydrophobizing agents, such as oils and fats, to flame-retardant and fireproofing agents, such as halogenated derivatives, to antismoke agents or to inorganic or organic reinforcing fillers, such as calcium carbonate, talc or kevlar.

The additive can also be an agent which improves or adjusts the conductive or insulating properties with regard to electricity or heat or the leaktightness, for example toward air, water, gases, solvents, fatty substances, gasolines, aromas or fragrances, chosen in particular from inorganic materials, salts and organic substances, in particular from agents which conduct or dissipate heat, such as metal powders and graphites.

The additive can also be an agent which improves the organoleptic properties, in particular:
scented properties (fragrances or odor-masking agents),
optical properties (gloss agents, whiteness agents, such as titanium dioxide, dyes, pigments, dye enhancers, opacifiers, mattness agents, such as calcium carbonate, thermochromic agents, phosphorescence and fluorescence agents, metalizing or marbling agents and antimist agents),
sound properties (barium sulfate and barites), and
tactile properties (fatty substances).

The additive can also be an agent which improves or adjusts the adhesive properties, in particular the properties of adhesion with regard to cellulose materials, such as paper or wood, metal materials, such as aluminum and steel, materials made of glass or ceramic, textile materials and inorganic materials, such as, in particular, pine resins, rosins, ethylene/vinyl alcohol copolymers, fatty amines, lubricating agents, mold-release agents, antistatic agents and antiblocking agents.

Finally, the additive can be an agent which improves the durability of the material or an agent for controlling its (bio)degradability, chosen in particular from hydrophobizing or beading agents, such as oils and fats, corrosion inhibitors, antimicrobial agents, such as Ag, Cu and Zn, decomposition catalysts, such as oxo catalysts, and enzymes, such as amylases.

For the purpose of the preparation of the composition according to the invention, use may be made of numerous processes providing in particular for extremely varied moments and orders of introduction of the components of said composition (polyolefin, amylaceous material, plasticizer for amylaceous material, plant fiber or filler, optional coupling agent, optional agent for improving the impact strength, other optional additives).

Thus, the plant fiber and/or filler can be introduced after having, in all or part, been predispersed in a composition already comprising the amylaceous material, its plasticizer and the polyolefin. In addition, in the final composition, said plant fiber and/or filler, whatever the way in which and the moment at which it was incorporated, can be dispersed mainly either in the plasticized amylaceous material or in the polyolefin phase, indeed even can be distributed between these two phases.

Among all these possibilities of processing said components, the present invention has in particular as subject matter a process for the preparation of a thermoplastic composition according to the invention as described above in all its alternative forms, said process comprising the following stages:

(i) selection of at least one thermoplastic composition (a) comprising at least one amylaceous material, one plasticizer for said amylaceous material with a molar mass of greater than 18 g/mol and less than 5000 g/mol and one polyolefin, the amylaceous material being plasticized by thermomechanical mixing with said plasticizing agent,

(ii) selection of at least one plant material (b) chosen from plant fibers and plant fillers, which plant material is composed of particles having a dimension of between 0.5 and 5000 micrometers and is preferably chosen from:
native or modified granular starches,
coproducts from starch, flour, sugar, paper or oil mills,
cellulose or lignocellulose fibers,
algae and algal extracts, and
any mixture of at least any two of these products, and

(iii) thermomechanical mixing of the composition (a) and of the plant material (b) so as to obtain the thermoplastic composition according to the invention.

Said composition (a) can in particular correspond to the “intermediate composition” as described above in all its alternative forms.

The incorporation of the plasticizer can be carried out under cold conditions prior to the thermomechanical mixing thereof with the amylaceous material. The thermomechanical mixing carried out to plasticize the amylaceous material is carried out under hot conditions at a temperature preferably of between 60 and 200° C., more preferably between 80 and 185° C. and in particular between 100 and 160° C., batchwise, for example by kneading/mixing, or continuously, for example by extrusion. The duration of this mixing can range from a few seconds to a few hours, according to the mixing method selected.

Furthermore, the incorporation of the plant material (b) (stage (iii)) can be carried out by physical mixing under cold conditions or at low temperature with the composition (a) but preferably by mixing under hot conditions at a temperature greater than the highest glass transition temperature of the composition (a). This mixing temperature is advantageously between 80 and 200° C., preferably between 120 and 185° C. and more preferably still between 160 and 180° C. This incorporation can be carried out by thermomechanical mixing, batchwise or continuously, and in particular in line. In this case, the duration of mixing can be short, from a few seconds to a few minutes. A very homogeneous thermoplastic composition is thus obtained, as can be found by observation under a microscope. Very obviously, when the plant filler introduced is starch, stage (iii) is carried out so that this starch remains in the filler state and is not plasticized, that is to say by using a mixing time which is sufficiently short not to plasticize the granular starch.

Preferably, the plant material selected exhibits, during the processing thereof, that is to say during the incorporation thereof to form the composition according to the invention, a water content corresponding to its equilibrium moisture content in an atmosphere at 66% relative humidity and a temperature of 20° C. This water content is ordinarily between 5 and 20% and generally between 8 and 15%.

Preferably, the process according to the invention is characterized in that the mixing stage (iii) is followed by a treatment for forming the thermoplastic composition according to the invention (iv) at a temperature between 80 and 200° C., preferably between 120 and 185° C. and in particular between 160 and 180° C.

In the context of its research studies, the applicant company has found that, contrary to all expectation, the introduction of plant material (b) makes it possible to considerably reduce the sensitivity to water, to steam and to heat of the final composition obtained, in comparison with the products prepared without the addition of plant material. This opens the route to novel applications for the compositions of the invention, which additionally exhibit the advantage of consisting to a very high extent of renewable starting materials and of being able to exhibit properties of thermoplasticity suitable for forming according to the processes in place in the plastics industry or wood industry, of physicochemical stability which satisfy the processing conditions, of sufficient stability toward aging, in particular with regard to oxygen, carbon oxide gas, UV radiation, fatty substances, aromas, gasolines and fuels, and of recyclability.

Another subject matter of the present invention is furthermore the use of a composition comprising at least one amylaceous material plasticized by a plasticizer with a molar mass of greater than 18 g/mol and less than 5000 g/mol as agent for compatibilization between a plant material (b) and a polyolefin. Another subject matter of the invention is a process for improving the compatibility between a plant material and a polyolefin, characterized in that it comprises the following stages:
i. selection of at least one plant material chosen from plant fibers and plant fillers and of at least one polyolefin,
ii selection of at least one amylaceous material plasticized by a plasticizer with a molar mass of greater than 18 g/mol and less than 5000 g/mol, and
iii. mixing, preferably thermomechanical mixing, of the plant material and of the polyolefin in the presence of said amylaceous material, so as to improve the plant material/polyolefin compatibility within the resulting thermoplastic composition.

Stage (iii) is carried out at a temperature advantageously of between 80 and 200° C., preferably of between 120 and 185° C. and more preferably still of between 160 and 180° C.

The thermoplastic composition according to the invention can be used as is or as a mixture with other products or additives, including other synthetic or artificial polymers or polymers of natural origin. It is preferably nonbiodegradable and noncompostable within the meaning of standards EN 13432, ASTM D 6400 and ASTM D 6868, and for this reason constitutes a carbon well or trap by virtue of its great richness in plant products of photosynthetic origin.

The composition according to the invention advantageously comprises at least 51%, preferably at least 55% and in particular more than 60% of bioresourced materials based on carbon of renewable origin (ASTM D 6852 and/or ASTM D 6866) expressed by dry weight with respect to the dry weight of said composition. This carbon of renewable origin is the constituent carbon of the starch necessarily present in the composition in accordance with the invention and the constituent carbon of the plant material (b) also necessarily present, but can also be the carbon of the polyolefin, which is preferably biosourced, the carbon of the other optional constituents of the composition, such as the plasticizer, in particular if it is glycerol or sorbitol, or of any other product when it originates from renewable natural resources.

It is possible in particular to envisage using the compositions according to the invention as bioplastic materials or composite materials of use in the preparation, by injection molding, extrusion, blow molding, calendering, molding, thermoforming, compacting, spinning, “needling” or other techniques, of articles, of components, of bottles, of jars, of containers, of tanks, of sheets, of panels, of bars, of brackets, of beam sections, of tables, of interior furniture, of street furniture, of mats, of nonwovens, of door linings, of walls, of insulating layers, of automobile components, of electrical components, of cables, of sheaths, of instrument panels, of hoods or other standard products for domestic use, such as sports equipment and recreational articles, domestic electrical appliances, tools of use in various industries, such as, for example, the construction, packaging, electrical, transportation and equipment industries.

Said composition can be provided in the pulverulent, granulated or bead form. It can constitute, as such, a masterbatch or the matrix of a masterbatch intended to be diluted in a biosourced or nonbiosourced matrix. It can also constitute a plastic starting material or a compound which can be used directly by a components manufacturer or a custom molder of plastic articles. It can also constitute a final or intermediate composition capable of being shaped or used in the wood processing industry as a wood panel or a wood/polymer composite.

A better understanding of the invention will be obtained in the light of the following examples, which are not meant under any circumstances to limit the invention.

### EXAMPLE 1

### Compositions, in Accordance with or Not in Accordance with the Invention, Based on Sisal

Preparation of the Compositions

The choice is made, for this example, as thermoplastic composition (a), of a composition comprising, by dry weight:
on the one hand, 52% of a thermoplastic starch obtained from:
   native starch sold by the applicant company under the name “Wheat Starch SP” exhibiting a water content of approximately 12%,
   an aqueous plasticizing composition formed of polyols based on glycerol and sorbitol, sold by the applicant company under the name POLYSORB® G 84/41/00 having a water content of approximately 16%,
   and 1% of methylenediphenyl diisocyanate (MDI),
and, on the other hand, 48% of a polyolefin consisting of a blend of a commercial ungrafted polypropylene and of a commercial grafted polypropylene.

This thermoplastic composition (a) is obtained according to the process in accordance with patent application WO 2010/010282, published on behalf of the applicant company, this being done using a TSA brand twin-screw extruder, having a diameter (D) of 26 mm and a length of 50 D, so as to obtain a total material flow rate of 15 kg/h, the following extrusion conditions being retained:
Temperature profile (ten heating zones Z1 to Z10): 200/120/140/140/160/170/160/150/160/160,
Screw speed: 200 rev/min.

The constituents of the thermoplastic composition (a) are introduced into the extruder in the following way:

the polyolefin, in the main hopper of the extruder, following which it passes through all of the ten heating zones Z1 to Z10 of the extruder,
the plasticizer for the amylaceous component (POLYSORB®) at the zone Z2, the plasticizer/wheat starch ratio being set at 67 parts/100 parts,
the amylaceous component (nonplasticized wheat starch) at the zone Z3,
and the coupling agent at the zone Z7.
Extraction of water is carried out by slight negative pressure at the zone Z6.

This composition comprises 52% of material of renewable origin in the form of wheat starch and of plasticizers of biosourced polyols type. It exhibits a density of approximately 1.11. This thermoplastic composition (a) is referred to as “Resin A” and it is used as “intermediate composition” by combining it, for the purpose of obtaining a composition according to the invention, with a plant material (b) composed of sisal fibers, the main dimension (length) of which is of the order of 500 micrometers. 25% by commercial weight of sisal fibers, comprising approximately 8.5% of water, with respect to the total weight of the composition according to the invention, are mixed with Resin A.

The conditions for preparation by extrusion through a 6 mm die are as follows:
Temperature profile (4 heating zones): profile increasing from 165° C. to 175° C.
Face cutter temperature: 200° C.
Venting of the water from the material before exiting from the extruder
Screw speed: 350 rev/min
Throughput: 350 kg/h.

At the extruder outlet, the rods are cooled under water at 20° C. and dried at 80° C. under vacuum for 4 hours. The density of the composition according to the invention thus obtained is approximately 1.13. It comprises approximately 23.4% of plant fibers, this percentage being expressed by dry weight with respect to the dry weight of the thermoplastic composition according to the invention.

A control composition 2 is prepared in an identical manner using, instead of Resin A, a mixture (control composition 1) comprising 97% of polypropylene of PPC16N copolymer type with an MFI (Melt Flow Index) of 16 (230° C.; 2.16 kg) exhibiting mechanical characteristics very similar to those of Resin A and 3% of polypropylene grafted with 1% of maleic anhydride as compatibilizing agent. Only the extrusion conditions through the 6 mm die are slightly modified in the sense that:
the profile is increasing from 190° C. to 210° C.,
and the face cutter temperature is set at: 220° C.

Mechanical Characteristics of the Compositions in Accordance or not in Accordance with the Invention

| | Un- | | | | | |
|---|---|---|---|---|---|---|
| | notched | Notched | | | | |
| | Charpy | Charpy | | | | |
| | impact | impact | Tensile | | Flexural | |
| | ISO | ISO | modu- | Max. | modu- | Max. |
| | 179/ | 179/ | lus | strength | lus | strength |
| | 1eU | 1eA | ISO 527 | ISO 527 | ISO 178 | ISO 178 |
| | kJ/m² | kJ/m² | MPa | MPa | MPa | MPa |
| Resin A | No | 9.85 | 722 | 18 | 553 | 26 |
| (thermoplastic | failure | | | | | |
| composition | | | | | | |
| (a)) | | | | | | |
| Resin A and | 20.1 | 8.3 | 2325 | 39 | 2300 | 59 |
| 23.4% sisal | | | | | | |
| (composition | | | | | | |
| according to | | | | | | |
| the invention) | | | | | | |
| PPC16N + 3% | 110 | 9 | 1500 | 26 | 1500 | |
| compatibilizing | | | | | | |
| agent | | | | | | |
| (control | | | | | | |
| composition | | | | | | |
| 1) | | | | | | |
| Control | 15.4 | 6.7 | 2100 | 28 | 2050 | 50 |
| composition 1 | | | | | | |
| and 23.4% | | | | | | |
| sisal | | | | | | |
| (control | | | | | | |
| composition | | | | | | |
| 2) | | | | | | |

It is observed that the composition according to the invention exhibits much better mechanical characteristics than the control composition 2, this being the case for all of the criteria measured. The plasticized starch present in Resin A appears to act both on improving the adhesion to the sisal fibers and on improving the compatibility with the polypropylene.

The composition according to the invention can furthermore be obtained by the same process as that normally applied and advantageously without modifying the tooling and while operating at temperatures lower by 20 to 35° C. below the control composition 2. This makes possible not insignificant savings in energy and makes it possible to reduce the requirements for resources of fossil origin but also makes possible the reduced deterioration in the reinforcing properties conferred by the plant fibers with regard to the polymeric matrix.

Furthermore, the composition according to the invention, in contrast to the control composition 2, exhibits a beautiful natural appearance and high uniformity. It also exhibits a pleasant feel which is explained by the presence of starch used in the thermoplastic composition (a).

It is found that the composition according to the invention, comprising in total 64% approximately of biosourced material, exhibits numerous technical advantages in comparison with the control composition 2 which nevertheless comprises only 23.4% of material of renewable natural origin.

### EXAMPLE 2

### Compositions, in accordance or not in accordance with the Invention, Based on Wood Flours

A) The procedure given in EXAMPLE 1 is retained, use being made, in place of sisal fibers, in combination with Resin A (composition according to the invention) or with PPC16N (control composition), of:
17.6% approximately, with respect to the final composition (dry/dry), of a sawdust comprising particles of the size of between 0.5 and 3 millimeters, and
17.6% approximately, with respect to the final composition (dry/dry), of a wood flour comprising particles of the size of approximately 250 micrometers.
   This sawdust and this wood flour respectively exhibit, at the moment of the introduction thereof into Resin A or PPC16N, a water content of approximately 11.5% and 12.4%.
   The results obtained for the mechanical tests are as follows:

| | Unnotched | Notched | | | | |
|---|---|---|---|---|---|---|
| | Charpy | Charpy | | | | |
| | impact | impact | Tensile | | Flexural | |
| | ISO | ISO | modu- | Max. | modu- | Max. |
| | 179/ | 179/ | lus | strength | lus | strength |
| | 1eU | 1eA | ISO 527 | ISO 527 | ISO 178 | ISO 178 |
| | kJ/m² | kJ/m² | MPa | MPa | MPa | MPa |
| Resin A and | 14.1 | 5.3 | 4150 | 37 | 3375 | 65 |
| 35.2% of | | | | | | |
| wood | | | | | | |
| (composition | | | | | | |
| according | | | | | | |
| to the | | | | | | |
| invention) | | | | | | |
| PPC16N and | 10.0 | 3.5 | 3900 | 30 | 3200 | 46 |
| 35.2% of | | | | | | |
| wood | | | | | | |
| (control | | | | | | |
| composition) | | | | | | |

It is found that the composition according to the invention, which comprises, in total, approximately 69% of biosourced material, exhibits much better mechanical properties than the control composition which nevertheless comprises only 35% approximately of material of renewable natural origin.

B) The choice is made, for this example, of different intermediate thermoplastic compositions for the purpose of manufacturing compositions according to the invention and comparative compositions.

The first intermediate composition comprises, by dry weight:
on the one hand, 52% of a thermoplastic starch obtained from:
   native starch sold by the applicant company under the name “Wheat Starch SP” exhibiting a water content of approximately 12%,
   an aqueous plasticizing composition formed of polyols based on glycerol and sorbitol, sold by the applicant company under the name POLYSORB® G 84/41/00 having a water content of approximately 16%,
   and 1% of methylenediphenyl diisocyanate (MDI),
and, on the other hand, 48% of a polyolefin consisting of a blend, in equal proportions, of a commercial ungrafted polypropylene and of a commercial grafted polypropylene.

The second intermediate composition is identical to the first composition, except that the thermoplastic starch does not comprise MDI.

The third intermediate composition consists of the mixture of an ungrafted polypropylene and of a grafted polypropylene used for the manufacture of the first two intermediate compositions.

These intermediate compositions are obtained according to the process of example 1.

Compositions A (according to the invention), B (according to the invention) and C (comparative) are obtained by respectively mixing the first, second and third intermediate compositions with:
17.6% approximately, with respect to the final composition (dry/dry), of a sawdust comprising particles with a size of between 1 and 2 millimeters, and
17.6% approximately, with respect to the final composition (dry/dry), of a wood flour comprising particles with a size of approximately 220 micrometers.
   The results obtained for the mechanical tests are as follows:

| | Un- | | | | | |
|---|---|---|---|---|---|---|
| | notched | Notched | | | | |
| | Charpy | Charpy | | | | |
| | impact | impact | Tensile | | Flexural | |
| | ISO | ISO | modu- | Max. | modu- | Max. |
| | 179/ | 179/ | lus | strength | lus | strength |
| | 1eU | 1eA | ISO 527 | ISO 527 | ISO 178 | ISO 178 |
| | kJ/m² | kJ/m² | MPa | MPa | MPa | MPa |
| Intermediate | NB | 8.5 | 560 | 14.8 | 465 | 21.3 |
| composition 1 | | | | | | |
| (reference) | | | | | | |
| Composition A | 15.5 | 6.5 | 3375 | 33.15 | 2725 | 55 |
| (invention) | | | | | | |
| Intermediate | NB | 8.5 | 560 | 14.8 | 465 | 21.3 |
| composition 2 | | | | | | |
| (reference) | | | | | | |
| Composition B | 15 | 6.5 | 3250 | 30 | 2825 | 56.5 |
| (invention) | | | | | | |
| Intermediate | NB | 66 | 630 | 17 | 600 | 25.2 |
| composition 3 | | | | | | |
| (reference) | | | | | | |
| Composition C | 34 | 14 | 1850 | 25 | 1550 | 42 |
| (comparative) | | | | | | |

It is observed that the introduction of plant fillers into the compositions comprising the plasticized starch (with or without MDI) makes it possible to bring about a much greater improvement in the tensile modulus (modulus six times greater) than when the composition does not comprise them (modulus three times greater only). In this composition comprising plant fillers, the introduction of MDI makes possible a slight enhancement in the tensile and impact properties.

### EXAMPLE 3

### Compositions, in Accordance or not in Accordance with the Invention, Based on Waxy Corn Native Starch

Preparation of the Compositions

The choice is made, for this example, of Resin A as described above as thermoplastic composition (a) or intermediate composition which can be used according to the invention.

A composition according to the invention is prepared using, as plant material (b), in this case as plant filler, a waxy corn native starch sold by the applicant company.

40% by commercial weight of said waxy native starch comprising approximately 12% of water, with respect to the total dry weight of composition according to the invention, are mixed with Resin A.

The conditions for the preparation by extrusion through a die with a diameter of 3 cm are as follows:
Temperature profile (20/80/180/180/180/180/180/180 for 8 heating zones)
Face cutter temperature: 180° C.
Venting of the water from the material before the outlet of the extruder
Screw speed: 200 rev/min
Throughput: 5 kg/h.

The thermoplastic composition according to the invention thus obtained comprises approximately 35% by weight of plant filler, this percentage being expressed by dry weight with respect to the dry weight of the thermoplastic composition according to the invention.

A control composition is prepared in an identical manner using, instead of Resin A, a polypropylene of homopolymer type, Moplen HP456J, with an MFI of 16 (230° C.; 2.16 kg), exhibiting superior mechanical characteristics to those of Resin A in terms of modulus of strength and of stiffness. 4% of polypropylene grafted with maleic anhydride are added to this polypropylene as compatibilizing agent between the polypropylene and the fillers of hydrophilic nature.

Mechanical Characteristics of the Compositions in Accordance or not in Accordance with the Invention

| | Flexural modulus | Max. strength |
|---|---|---|
| | (MPa) | (MPa) |
| | ISO 178 | ISO 527 |
| Resin A (thermoplastic | 580 | 17 |
| composition (a)) | | |
| Resin A and 35% waxy corn native | 1688 | 22 |
| starch (composition according to | | |
| the invention) | | |
| Moplen HP456J PP | 1522 | 35 |
| (control PP alone) | | |
| Moplen HP456J PP and 35% waxy | 2134 | 34 |
| corn native starch + 4% | | |
| compatibilizing agent (control | | |
| composition) | | |

It is observed that the reinforcing effect of the waxy corn starch filler on the properties of flexural modulus (stiffness) and of strength (maximum strength) is much greater for Resin A than for the polypropylene base which additionally has a compatibilizing agent.

Specifically, while the modulus is three times greater for the compounded Resin A with respect to the virgin Resin A, the polypropylene modulus is increased only by a factor of 1.4.

Furthermore, no effect on the maximum strength is visible for the polypropylene, whereas the composition according to the invention makes it possible to increase the strength (maximum strength) by 5 MPa.

The fact of compounding Resin A, an intermediate composition which can be used according to the process of the invention, thus exhibits a very advantageous gain with regard to the effectiveness of the enhancement in the mechanical properties, in comparison with the polypropylene-base control conditions, while making it possible to dispense with the use of grafted polypropylene as compatibilizing agent. The plasticized starch present in Resin A appears to act both on the improvement in the adhesion of the starch fillers and on the improvement in the compatibility with the polypropylene.

Furthermore, it is found that the composition according to the invention, which comprises in total approximately 71% of biosourced material, exhibits modulus of stiffness properties which are relatively close to those of the control composition which nevertheless comprises only 35% approximately of material of renewable natural origin.

1-21. (canceled)

22. A thermoplastic composition, comprising:
a) from 15 to 60% of at least one amylaceous material,
b) from 10 to 30% of at least one plasticizing agent for amylaceous material with a molar mass of greater than 18 g/mol and less than 5000 g/mol,
c) from 15 to 65% of at least one polyolefin, and
d) from 10 to 40% of at least one plant material chosen from plant fibers and plant fillers,
said amylaceous material a) being plasticized by the plasticizing agent b) and these percentages being expressed by dry weight, with respect to the dry weight of said composition.

23. The composition according to claim 22, wherein it comprises:
a) from 15 to 50% of at least one amylaceous material,
b) from 10 to 25% of at least one plasticizing agent for amylaceous material.
c) from 25 to 50% of at least one polyolefin, and
d) from 15 to 40% of at least one plant material chosen from plant fibers and plant fillers.

24. The composition according to claim 22, wherein it comprises, in total, at least 27%, or from 30 to 80%, or from 35 to 75%, of at least one amylaceous material and of at least one plasticizer for amylaceous material, these percentages being expressed by total dry weight of amylaceous material(s) and of plasticizer(s) for amylaceous material, with respect to the dry weight of the thermoplastic composition.

25. The composition according to claim 22, wherein it comprises, in total, at least 52%, or from 55 to 90%, of at least one amylaceous material, of at least one plasticizer for amylaceous material and of at least one polyolefin, these percentages being expressed by total dry weight of amylaceous material(s), of plasticizer(s) for amylaceous material and of polyolefin(s), with respect to the dry weight of the thermoplastic composition.

26. The composition according to claim 22, wherein the polyolefin is selected from the group consisting of:
a) homopolymers of olefins,
b) copolymers based on at least two olefins,
c) homopolymers of olefins functionalized or grafted i) by acids or anhydrides, ii) by oxiranes, or iii) by silanes,
d) copolymers based on at least two olefins, and
e) any blend of at least any two of the abovementioned products.

27. The composition according to claim 22, wherein the plant material is composed of particles having a dimension of between 0.5 and 5000 micrometers.

28. The composition according to claim 22, wherein the plant material is composed of particles having a dimension of between 0.5 and 5000 micrometers and is selected from the group consisting of:
native or modified granular starches,
coproducts from starch, flour, sugar, paper or oil mills,
cellulose or lignocellulose fibers,
algae and algal extracts, and
any mixture of at least any two of these products.

29. The composition according to claim 22, wherein the amylaceous material is selected from the group consisting of native starches, pregelatinized starches, extruded starches, atomized starches, fluidized starches, oxidized starches, cationic starches, anionic starches, hydroxyalkylated starches, crosslinked starches, starch acetates, fatty esters of starch and of fatty chains of 4 to 22 carbons, dextrins, maltodextrins and any mixture of these products.

30. The composition according to claim 22, wherein the plasticizing agent for the amylaceous material exhibits a molar mass of less than 1000, or of less than 400, or at most equal to 380.

31. The composition according to claim 22, wherein said composition comprises at least 51%, or at least 70%, or more than 80%, of carbon-based biosourced materials of renewable origin, expressed by dry weight with respect to the dry weight of said composition.

32. The composition according to claim 22, wherein said composition is nonbiodegradable or noncompostable.

33. The composition according to claim 22, wherein said composition simultaneously exhibits:
a maximum flexural strength of greater than 30 MPa, and
a maximum tensile strength of greater than 50 MPa.

34. The composition according to claim 22, wherein said composition exhibits a flexural modulus (ISO 178) and a tensile modulus (ISO 527) which are greater than 1500 MPa.

35. The composition according to claim 22, wherein said composition exhibits a density of between 1.05 and 1.25 or between 1.1 and 1.2.

36. The composition according to claim 22, wherein said composition further comprises an agent which improves its impact strength.

37. The composition according to claim 22, wherein said composition further comprises an agent which improves its impact strength in a proportion of 1 to 15% by weight (dry/dry).

38. The composition according to claim 22, wherein said composition further comprises an agent which improves its impact strength at a temperature of 23° C. or less, and said agent is selected from the group consisting of polymers of ethylene/propylene, ethylene/styrene or styrene/butadiene copolymer type and elastomeric materials of natural rubber, styrene/butylene/styrene (SBS) copolymer and styrene/ethylene/butylene/styrene (SEBS) copolymer type.

39. The composition according to claim 22, wherein said composition further comprises a polymer or copolymer other than a polyolefin selected from the group consisting of polyurethanes (PUs), thermoplastic polyurethanes (TPUs), polyamides, polylactates (PLAs), polybutylene succinates (PBSs, PBSAs), polyhydroxyalkanoates (PHAs, PHBs, PHBVs) and any mixtures thereof.

40. A process for the preparation of a thermoplastic composition as claimed in claim 22, said process comprising:
(i) selection of at least one thermoplastic composition (a) comprising at least one amylaceous material, one plasticizer for said amylaceous material with a molar mass of greater than 18 g/mol and less than 5000 g/mol and one polyolefin, the amylaceous material being plasticized by thermomechanical mixing with said plasticizing agent,
(ii) selection of at least one plant material (b) chosen from plant fibers and plant fillers, which plant material is composed of particles having a dimension of between 0.5 and 5000 micrometers, and
(iii) thermomechanical mixing of the composition (a) and of the plant material (b) so as to obtain a thermoplastic composition according to claim 22.

41. The process according to claim 40, wherein the composition (a) comprises:
a) from 17 to 65%, or from 20 to 65%, of at least one amylaceous material,
b) from 12 to 30%, or from 12 to 25%, of at least one plasticizing agent for amylaceous material, and
c) from 17 to 70%, or from 17 to 65%, of at least one polyolefin, these percentages being expressed by dry weight, with respect to the dry weight of said composition (a).

42. The process according to claim 40, characterized in that the composition (a) comprises:
a) from 25 to 60% of at least one amylaceous material,
b) from 15 to 25% of at least one plasticizing agent for amylaceous material, and
c) from 25 to 60% of at least one polyolefin,
these percentages being expressed by dry weight, with respect to the dry weight of said composition (a).

43. The process according to claim 40, wherein stage (iii) is carried out at a temperature of between 80 and 200° C., or between 120 and 185° C., or between 160 and 180° C.

44. The process according to claim 40, wherein said particles are selected from the group consisting of:
native or modified granular starches,
coproducts from starch, flour, sugar, paper or oil mills,
cellulose or lignocellulose fibers,
algae and algal extracts, and
any mixture of at least any two of these products.

45. A process for improving the adhesiveness or the bonding of plant fibers and/or fillers, comprising:
(i) selection of at least one plant material chosen from plant fibers and plant fillers,
(ii) selection of at least one composition comprising an amylaceous material plasticized by a plasticizer with a molar mass of greater than 18 g/mol and less than 5000 g/mol and a polyolefin, and
(iii) thermomechanical mixing of said plant material and said composition.

46. A process for improving the compatibility between a plant material and a polyolefin, comprising:
(i) selection of at least one plant material chosen from plant fibers and plant fillers and of at least one polyolefin,
(ii) selection of at least one amylaceous material plasticized by a plasticizer with a molar mass of greater than 18 g/mol and less than 5000 g/mol, and
(iii) thermomechanical mixing of the plant material and of the polyolefin in the presence of said amylaceous material, so as to improve the plant material/polyolefin compatibility within the resulting thermoplastic composition.
